(19) United States
(12) Patent Application Publication
(10) Pub. No.: US 2003/0030548 A1
(43) Pub. Date: Feb. 13, 2003

(54) Vehicle alarm system

(76) Inventors: Alex Kovacs, Ontario (CA); Karoly Szuper, Ontario (CA)

Correspondence Address: RANDALL J. KNUTH P.C., 3510-A STELLHORN ROAD, FORT WAYNE, IN, 46815-4631, US

(21) Appl. No.: 10/172,882

(22) Filed: Jun. 17, 2002

(30) Foreign Application Priority Data
Jun. 15, 2001 (CA) 2,350,856

(51) Int. Cl. B60R 25/10

(52) U.S. Cl. 340/426; 340/825.72; 340/539

(57) ABSTRACT

A vehicle alarm system comprising a remote control for activation and deactivation of the alarm system, a multiplicity of sensors for detecting an alarm event, a siren, and a control unit which comprise monitoring circuitry for monitoring the multiplicity of sensors, a receiver for receiving signals from the remote control, an activation and deactivation circuit for activating and deactivating the vehicle alarm system based on signals from the receiver, a cellular telephone interface unit, and an alarm triggering unit, whereupon the detection of an alarm event from one of the multiplicity of sensors, the control unit activates the siren through the alarm triggering unit, and whereupon the detection of an alarm event from one of the multiplicity of sensors, the control unit, through the cellular telephone interface unit, calls a telephone number of a user; and whereupon the detection of an alarm event from one of the multiplicity of sensors, the control unit signals to the user the cause of the alarm event.

### TECHNICAL FIELD OF THE INVENTION

The present invention relates to vehicle alarm systems, and in particular to vehicle alarm systems which intelligently interface with cellular telephone systems.

### BACKGROUND TO THE INVENTION

Alarm systems for vehicles are well known. The combined problem of vehicle theft and the increasing price of vehicles has made these alarms popular. However, present alarm systems suffer from a number of deficiencies.

One problem with most current systems is that upon an alarm event occurring, they merely activate a siren. While this may alert those around to a problem, car alarm sirens have become so common that often they are merely ignored. Further, the owner of the vehicle is only alerted to the car alarm if he or she is within hearing range of the siren, and thus will often be unaware that his or her vehicle has been hit, broken into, or towed away.

Several prior inventions have attempted to overcome this problem by attempting to contact the owner using the vehicle's mobile telephone system. These include U.S. Pat. No. 6,009,320 to Dudley, which teaches a system in which a preprogrammed telephone number is dialled upon the occurrence of an alarm event, and U.S. Pat. No. 5,247,564 to Zicker, which teaches a system in which the vehicle calls a series of preprogrammed number in response to alarm detection.

These systems, however, have several problems. The first is that even though they contact the owner, they do not give the user an indication about the cause of the alarm. This prevents the owner from being able to make an informed decision about whether to interrupt whatever he or she is doing in order to go check on the vehicle.

A second problem with the above systems is that they merely attempt to contact the user once, after which the alarm resets itself. If the vehicle is parked underground or in a remote location it is often not within cellular telephone range. Thus if an intruder steals the vehicle from these locations the owner will not be informed.

Other disadvantage of present alarm systems is that they have a siren which ignores the environment in which the vehicle is parked in. Thus the siren will sound for a predetermined time period, even if the vehicle is in a quiet residential neighbourhood. These prolonged sirens are irritating to those living in these areas.

Yet another problem with current alarm systems is that they often have sensors that are ignored in certain circumstances. Most vehicle alarms have a tilt sensor which detect unwanted lifting of the vehicle. These are, however, usually disabled by the system if the vehicle is parked on a hill, which makes the vehicle alarm system less effective, usually without the owner or vehicle user knowing.

### SUMMARY OF THE INVENTION

The present invention overcomes the deficiencies of the prior art by providing an alarm system which will communicate to a remote user that an alarm event has been detected in his vehicle. Further the present invention will communicate to the user the source of the alarm event. Also, if the vehicle for some reason cannot establish a communication link with the user it will continue to attempt to establish this communication link for a predetermined time period after the event has occurred.

The present invention further provides an alarm system that has advantages over other alarm systems. The present alarm system provides a siren that is sensitive to environmental conditions around the vehicle at the time an alarm event occurs. This enables the alarm to be sounded only for a short duration if the alarm event occurs in a quiet neighbourhood, eliminating annoyance to those within hearing distance of the alarm while still scaring an intruder away. It conversely allows the alarm to be sounded for a long duration in a noisy area, ensuring others hear the alarm.

The present invention further provides an alarm with sensors that are more intelligent than those in present alarm system. The invention provides a tilt sensor which automatically levels itself when the alarm is turned on, thus allowing a user to park on a hill and still use the sensor. The system further has the capability to distinguish between a gust of wind or other false input, and a true lifting or tilting of the vehicle.

The present invention therefore seeks to provide a vehicle alarm system comprising a remote control for activation and deactivation of said alarm system; a multiplicity of sensors for detecting an alarm event; a siren; a control unit comprising: monitoring circuitry for monitoring said multiplicity of sensors; a receiver for receiving signals from said remote; an activation and deactivation circuit for activating and deactivating said vehicle alarm system based on signals from said receiver; a cellular telephone interface unit; and an alarm triggering unit; whereupon the detection of said alarm event from one of said multiplicity of sensors said control unit activates said siren through said alarm triggering unit, and whereupon the detection of said alarm event from one of said multiplicity of sensors, said control unit, through said cellular telephone interface unit, calls a telephone number of a user; and whereupon the detection of said alarm event from one of said multiplicity of sensors, said control unit signals to said user the cause of the alarm event.

The present invention further seeks to provide a vehicle alarm system comprising a remote control for activation and deactivation of said alarm system, wherein said remote control is adapted to send a signal that is security coded and said signal differentiates between individual users; a multiplicity of sensors for detecting an alarm event, including an automatic zeroing tilt sensor comprising: a tilt sensitive diaphragm for producing a tilt value; comparison circuitry; activation circuitry; and a memory unit; wherein said activation circuitry signals to said memory unit upon activation of said vehicle alarm system to store tilt value at a moment shortly after said activation; and wherein said comparison circuitry compares said memory to said tilt value and sends an alarm event if the two become different; a siren; a control unit comprising: monitoring circuitry for monitoring said multiplicity of sensors; a receiver for receiving signals from said remote; an activation and deactivation circuit for activating and deactivating said vehicle alarm system based on signals from said receiver, wherein said activation and deactivation circuit is adapted to check said security code within said signals; a cellular telephone interface unit; and an alarm triggering unit; whereupon the detection of said alarm event from one of said multiplicity of sensors said control unit activates said siren through said alarm triggering unit, and whereupon the detection of said alarm event from one of said multiplicity of sensors, said control unit, through said cellular telephone interface unit, calls a telephone number of a user, said telephone number being determined by said signals from said remote control; and whereupon the detection of said alarm event from one of said multiplicity of sensors, said control unit signals to said user the cause of the alarm event.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a block diagram of the preferred embodiment of the system of the invention.

FIG. 2 is a block diagram of the preferred embodiment of the remote system of the present invention.

FIG. 3 is a block diagram of an alternative embodiment of the remote system of the present invention.

FIG. 4 is a schematic diagram of the functional portion of the present invention related to the differentiation of users.

FIG. 5 is a schematic diagram of the personal security car system of the present invention.

FIG. 6 is a schematic diagram of the green siren alarm system of the present invention.

FIG. 7 is a schematic diagram of the bump sensor of the present invention.

FIG. 8 is a schematic diagram of the automatic zeroing tilt sensor of the present invention.

### DETAILED DESCRIPTION

These above deficiencies in the prior art are overcome in the present invention. While the present invention is described below in terms of car or automobile alarms, this is done solely for illustrative purposes. It is envisioned that this system may be used for other vehicles such as boats, jet skis, snowmobiles, motorcycles, or recreational vehicles.

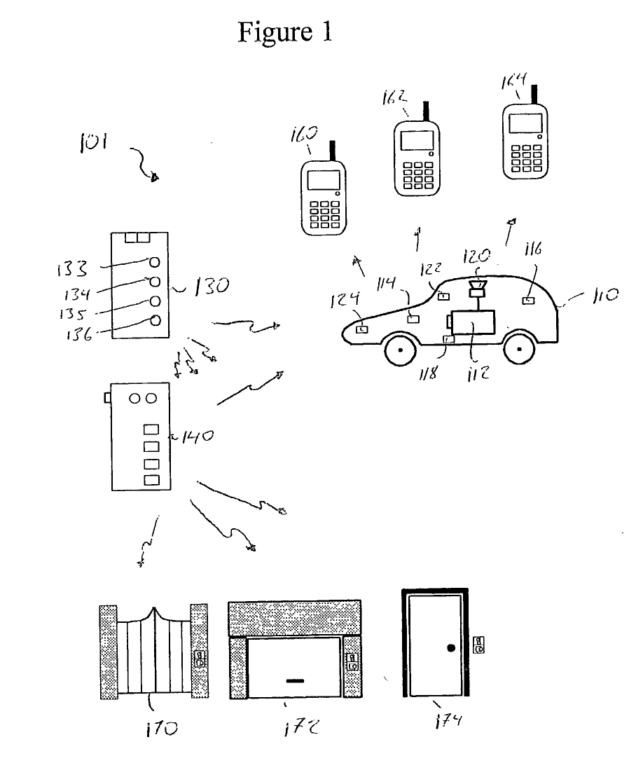

Reference is now made to the drawings. FIG. 1 shows a block diagram of the preferred embodiment of the present system 101. The present system is comprised of vehicle 110 in which a number of alarm system components and sensors are located, as is described below.

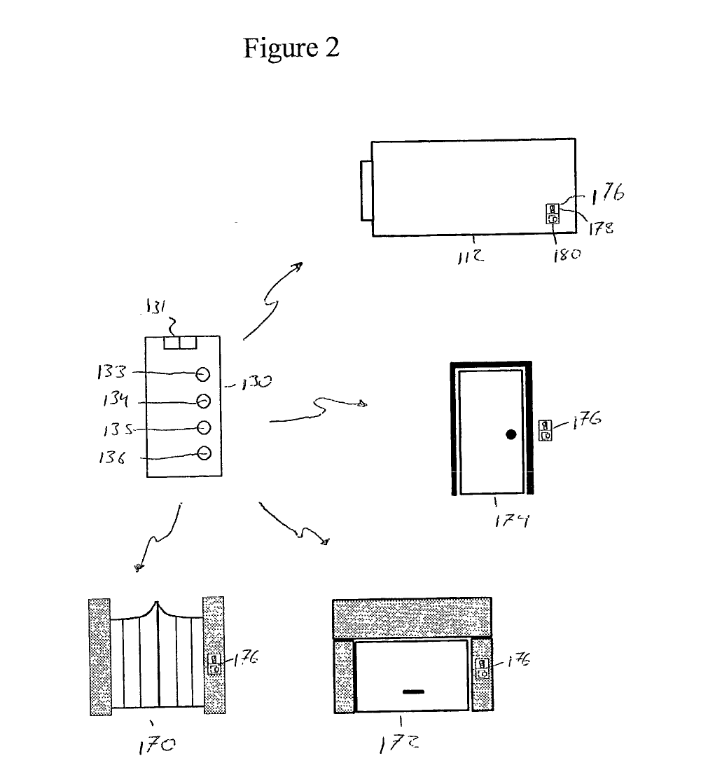

One essential component of the present system is the remote control. In typical operation, a user sets the alarm in vehicle 110 by pressing a single button on remote 130. Remote 130 is specially adapted for the present system as described below and shown in FIG. 2. Remote 130 sends a radio signal with certain identifying information to the personal security car system (PCSC) 112. PCSC 112 is the heart of the alarm system and includes a receiver for receiving this radio signal.

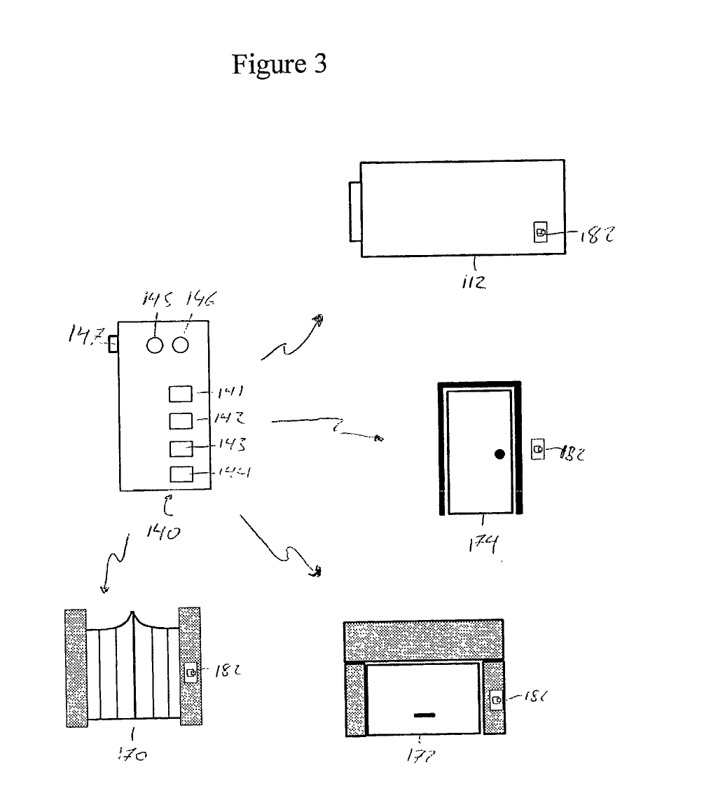

In an alternative embodiment, remote 140 may be used with the present system. Remote 140 has the option of using infrared signals instead of radio signals in order to prevent the radio code from being intercepted and used to disarm the present system. Remote 140 and its operation are described in more detail below with reference to FIG. 3.

Once PCSC 112 receives an activate signal, it enters a monitoring state and watches the sensors in the car. These sensors include impact sensor 114 which monitors both the vibrations on the vehicles exterior and the ambient noise in the environment, two-dimensional automatic zeroing position motion sensor 116, which adjusts itself to a level position when the alarm is activated, door sensors 118 which detect if the door is opened, and other sensors such as a hood and trunk sensor, ultrasonic sensors to detect if windows are broken, etc. Impact sensor 114 and motion sensor 116 are described in more detail below. The other sensors are well known in the art.

If one of the above sensors detects an alarm event, it notifies PCSC 112 of the event. PCSC 112 identifies which sensors detected the alarm event, and starts an alarm procedure. This procedure involves activating a siren or horn signal, which in the preferred embodiment consists of a siren that adjusts itself to based on the average ambient noise in the environment in which the vehicle is parked, referred to herein as green alarm system 120. It further uses a built in communications system such an internal cellular telephone system to call a preset number. In the preferred embodiment three numbers can be preset and the alarm will dial the number that was communicated to the alarm system when it was armed. It is however envisioned that more or less numbers can be programmed into the system. These preset numbers correspond to telephones 160, 162 and 164, which can be either the user's cellular telephone or a fixed line phone.

System 101 identifies the type of alarm based on which sensor detected it. PCSC 112 will then communicate to the remote user that an alarm event has occurred and further the type of alarm that has occurred. This presents the advantage that the user does not need to be within audible range of the vehicle in order to know that an alarm event has occurred, and it further signals to the user the severity of the alarm event, giving the user the option of checking on the vehicle immediately or ignoring the alarm. PCSC 112 communicates the type of alarm by calling the remote user and allowing the phone to ring a pre-specified number of times before hanging up and repeating. For example, if PCSC 112 detects a bump to the vehicle, it will first turn on the siren, which in the preferred embodiment is green alarm system 120. It further calls the preprogrammed telephone number of the user that set the alarm. Because the event that triggered the alarm was a bump event, PCSC 112 will allow the remote phone to ring 2 to 4 times before hanging up, waiting for a predetermined interval, and repeating.

The user who receives the remote call, if he or she is has call display, will see that the caller is “MY CAR” or another similar identifier. Further, the user can count the number of rings and know that a bump event occurred. In order to stop the cycle of the car phone ringing, the user can answer the phone and enter an acknowledging character. Alternatively, the user can reset the system with the vehicle's remote 130 or 140. In the absence of acknowledgement or deactivation of the alarm system, the PCSC 112 will continue to attempt to telephone the user or successfully phone and hang up for a period of 48 hours after the alarm event. This presents the advantage that if the vehicle is out of cellular range when the alarm event occurs, by for example being in a concrete parking garage, if an intruder drives the vehicle out of the garage and into cellular telephone coverage the owner will then be notified. As described in the background section above, most systems will try to signal once and upon failing will have reset themselves.

Similarly, if there is an intrusion into the vehicle, which can be detected by a door or trunk opening or by the ultrasonic sensor, PCSC 112 will call the user using 4-6 rings. Finally, if the car is tilted, for example by a tow truck, this can be communicated to the user using 6-12 rings. As will be appreciated by one skilled in the art, various other combinations or levels of security are possible, as is the possibility to use alternative means to communicate the type of alarm event. Such other possibilities could include digital voice messages, etc.

Once the user has acknowledged that the alarm event has occurred, he or she has several possibilities. The user can go to the vehicle to inspect whether there was any damage or whether the vehicle was taken. If the vehicle was taken, the user can call the PCSC 112 and activate vehicle control 124. Further, if the user has a video phone, the user can get images of who is in the driver's seat through CCD camera 122 which is mounted to the dash or rear view mirror.

Vehicle control 124 can include things like activating warning lights on the dash to simulate an engine problem, causing the fuel line to slowly restrict fuel to the engine, thus gradually bringing the vehicle to a stop, activating a speaker within the passenger compartment to allow communication between the intruder and the owner, or performing other functions such as communicating Global Position System (GPS) information to the owner. One skilled in the art will appreciate that other functions can be controlled by vehicle control 124.

As indicated above, PCSC 112 can be adapted to be controlled by either remote 130 or remote 140. Reference is now made to FIG. 2. FIG. 2 shows a system for remote 130. Remote 130 is an extended remote that may be used for both vehicles and other functions. In the illustrated system, remote 130 may be used for PSCS 112, or for external gate 170, garage door 172, or outer door 174 of an apartment or house. Other uses are envisioned and would be clear to one skilled in the art. The function the remote is being used for is controlled by switch 131.

Remote 130 can either operate in extended mode or in dual mode. Extended mode allows the introduction of coding sequences into the remote in order to make the remote more secure. Dual mode is similar to existing remote controls today, with one button pushed for both arming and disarming. The control for whether the system is in extended mode or dual mode is at receiver 176. Receiver 176 contains switch 178 to change between extended mode and dual mode. Receiver 176 further contains replaceable circuit card 180 onto which the extended code is programmed.

In operation, the user sets the alarm of PCSC 112 or locks gate 170, door 174, or closes garage 172 by moving switch 131 to the appropriate position and pressing one of buttons 133 to 135. It is envisioned that the present system may be used by up to three people, each using a designated button to arm the system. This allows the system to know who armed it and thus which telephone number to call if there is a problem.

Once armed, if the receiver is set to extended mode, the user must remember the extended code to disarm the system or open the doors or gates. The user presses button 136 in a series of combinations and time intervals. For example, if the code was 2:2, the use would push button 136 twice within a set time (e.g. 1.5 seconds), wait for a pause time of 2 to 8 seconds, and press button 136 twice more within the set time.

System 101 offer the further protection of detecting false attempts. If the system registers three unsuccessful disarming attempts it will block the decoding circuit for a period of 15 to 60 seconds. This will generally be too long for someone trying to guess the combination to wait.

In an alternative embodiment of the present invention, remote 140 may be used. Reference is now made to FIG. 3. As with remote 130, remote 140 can control multiple devices, including PSCS 112, gate 170, garage door 172, or exterior door 174. The system activates the alarms or locks the devices using user buttons 141-144 and on button 145. The user pushes his or her user button, followed by on button 145.

The system is deactivated using a three stage process. In the first step, the user enters a number into a number keypad on the remote (not shown). In this embodiment the code may be up to five characters in length, although it is envisioned that this could be extended.

The second step involves pressing the user button 141-145 associated with the user.

The third step involves the user pressing the off button. Once this button is pressed the remote actually transmits the code. In a further aspect of system 101, remote 140 is provided with switch 147 which changes the remote's operation from radio waves to infrared waves. The use of infrared rays provides the further advantage that it becomes significantly more difficult to capture the code for the remote.

In yet another aspect of system 101, remote 140 may be programmed with capabilities described herein as Control Plus. Control Plus allows the user to lend the vehicle to friends or family without disclosing the code. In this system, the user is able to program the remote to allow the vehicle alarm to be disarmed by only using steps 2 and 3 from above (i.e. only pressing the user button 141-144 associated with the user and then pressing the off button 146). The user may set the time period or the number of disarm events for which the Control Plus functionality will work, after which the remote reverts back to its original configuration and the access code is required to disarm the alarm system.

The present invention envisions the use of either remote 130 or remote 140, but not both. Accordingly, receivers 182 are different than receivers 176, and the system will be configured with the appropriate receiver for the type of remote the user chooses.

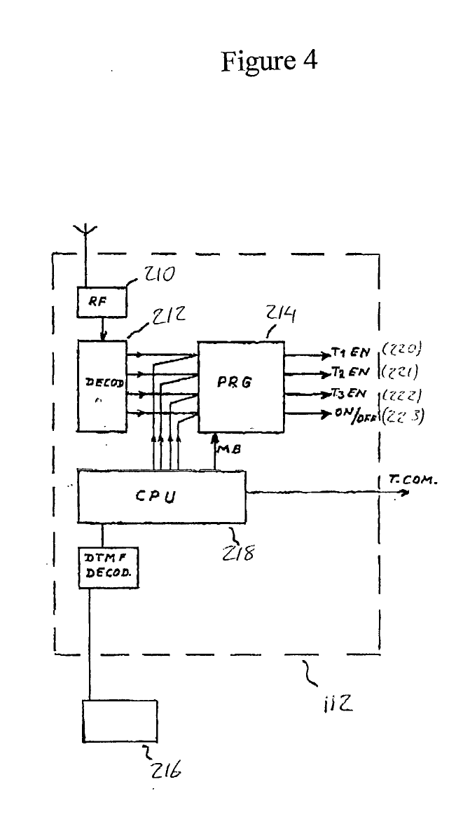

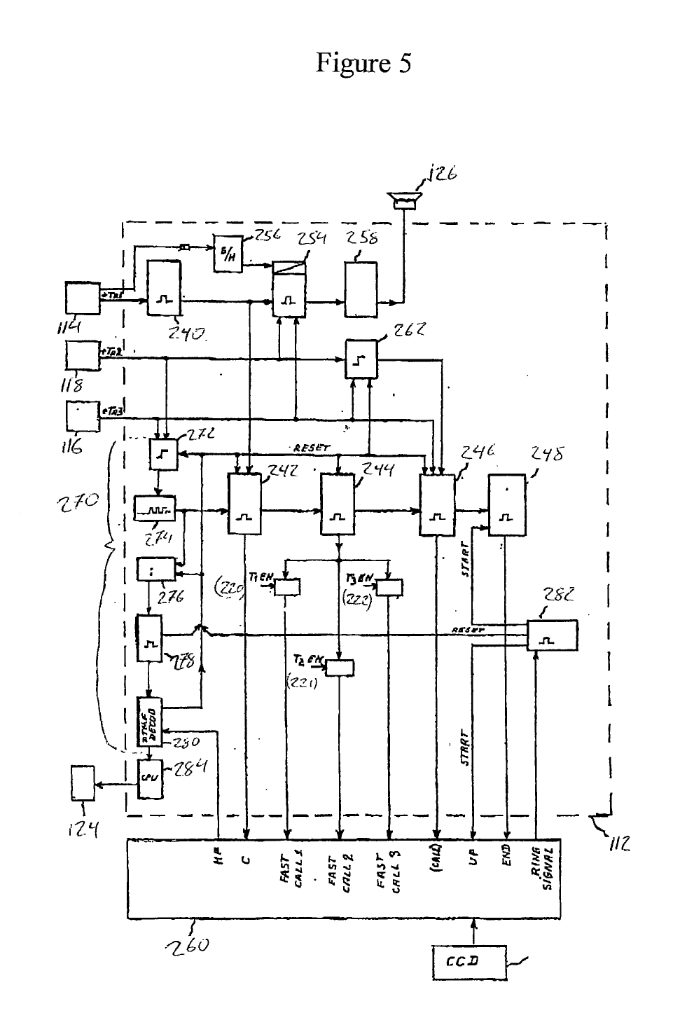

Reference is now made to FIGS. 4 and 5, which show the way PCSC 112 works. PCSC 112, as indicated above, differentiates between users when setting the alarm. This is done through Short Call Information System 200, as illustrated in FIG. 4. In Short Call Information System 200, the circuit receives a radio frequency signal and processes it at radio frequency converter 210. It then passes the signal to decoder 212 which decodes it and sends it to prioritizing decoder 214.

Prioritizing decoder 214 also receives information from the memory unit 216 which stores information about the what each individual users RF signal is. This is sent through central processing unit 218 to prioritizing decoder 214. Prioritizing decoder 214 then compares the signals and considers what state it is in, and depending on this information may activate one of its lines 220-223. For example, if the alarm system is off, and user 1 pushes the arm button, prioritizing decoder 214 detects that user 1 entered the arm signal and that the state of the system is off. Prioritizing decoder 214 will then set line 220 to high and the on/off line 223 to high, while leaving the others low.

When one of lines 220 to 223 is high, the system will not recognize any new arming of the system by a different user unless the system is first turned off.

When an alarm event occurs, the PCSC must attempt to contact the appropriate user, and must continue to do so if the trigger event was a certain type of alarm. The performance of this functionality is illustrated in FIG. 5.

PCSC 112 monitors a number of input signals to determine whether an alarm event has occurred. These include, but are not limited to, bump sensor 114, intrusion sensors 118, and tilt sensors 116. PCSC 112 further differentiates between these signals and modifies its response based on the type of signal received.

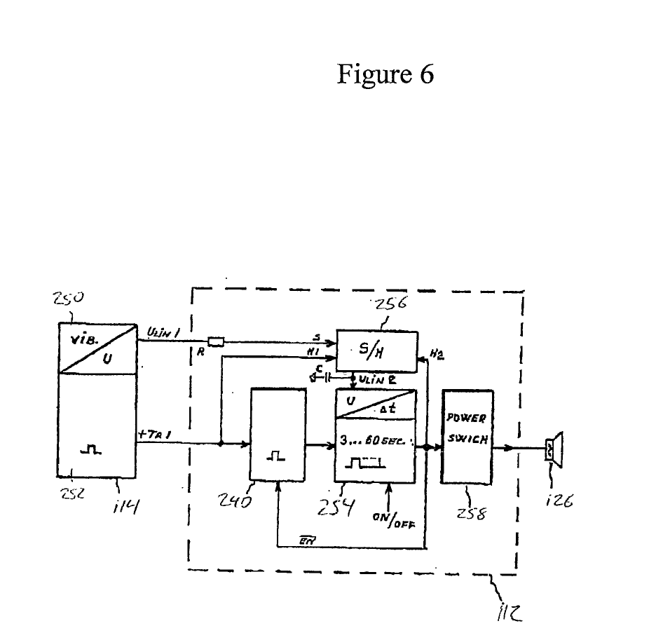

When impact sensor 114 detects impact with the vehicle it sends a signal that ultimately actives siren 126 and further activates a calling procedure to inform the user. In the preferred embodiment of the present invention this signal travels through Green Siren System 120 which then controls siren 126. Green alarm system 120 is shown in isolation of the PCSC in FIG. 6, as described below.

Bump sensor 114 has two components: a vibration voltage converter 250 and an ambient noise monitor 252. When an alarm event occurs, bump sensor 114 sends two signals, the first shown as U_{Lin1} which corresponds to a DC voltage corresponding to the average ambient noise in the environment, and the second, shown as TR1, which corresponds to an impact event.

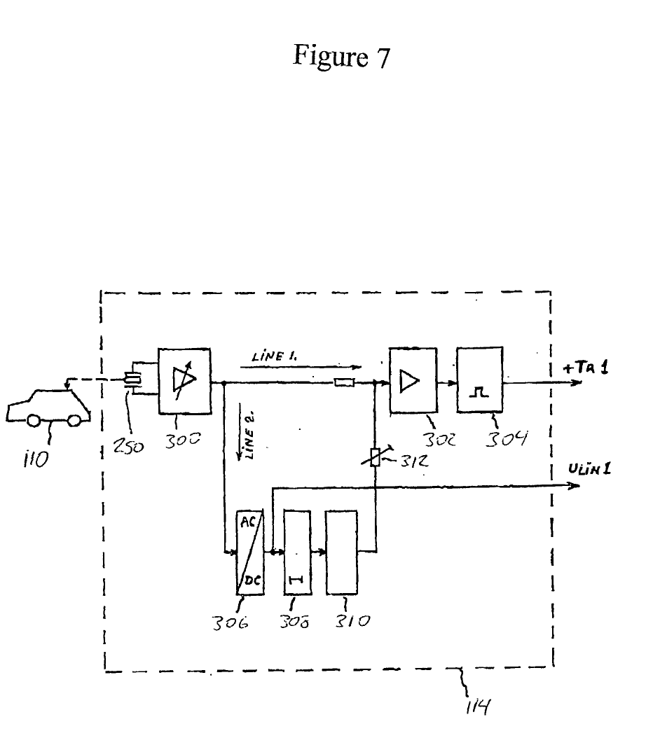

As shown in FIG. 7, vibration voltage controller 250 sends a signal to variable amplifier 300. Variable amplifier can be adjusted to the appropriate sensitivity so that false alarms due to gusts of wind and other factors can be minimized while still ensuring the alarm will be triggered if a true bump event occurs. The AC output from variable amplifier 300 is split into two lines. The first goes to amplifier 302, and trigger 304 which then send the trigger event along the TR1 line. The second goes to the AC to DC converter 306. The output of AC/DC converter stores the environmental noise at that moment and this is sent out as signal U_{Lin1}.

The output of converter 306 further goes to integrator 308, control 310 and variable resistor 312. This is thus a variable feedback loop which can be adjusted to further control the sensitivity of bump sensor 114.

The outputs of bump sensor 114 go directly to green alarm system 120. Green alarm system 120 comprises timer 254 which is triggered by one of the alarm sensors sending an trigger signal. Timer 254 further has an input from sampler 256, which monitors the ambient noise in the environment just prior to the alarm event and which takes the average of this noise. Based on these two inputs, timer sends a signal for a predetermined time interval to power switch 258, which controls siren 126. Thus the siren will be activated for the appropriate time period as determined by the environmental noise in the area prior to the alarm event.

The first signal from bump sensor 114, U_{Lin1,} is sent to sampler 256, along with TR1. Sampler 256 stores the U_{Lin1} signal for approximately 15 seconds. Sampler 256 further has an input from trigger TR1 which tells it that it should average the U_{LIn1} signal for the last 5 to 15 seconds. It then sends this information to timer 254.

The second signal from bump sensor 114, TR1, is further sent to trigger 240. Trigger 240 starts the alarm process and sends a signal to activate timer 254. Timer 254 determines the length the alarm should be based on the ambient noise information stored in sampler 256 and activates power switch 258 for that duration. Power switch 258 activates siren 126.

Trigger 240, along with sampler 256 further have blocking inputs which ensure that the alarm is not triggered a second time while it is still going off. These are show as signals H2 and EN in FIG. 6.

In operation, if green alarm system 120 is in a quiet environment it will only activate for a short period of time. The noisier the environment is, the longer the green alarm system 120 will activate for. In the preferred embodiment activation will occur for a period of 3 to 60 seconds.

Trigger 240 further activates circuitry to initiate a cellular telephone call to the a user. As shown in FIG. 5, trigger 240 sends a signal to timers 242, 244, 246 and 248. These timers communicate with the telephone interface 260. These timers set up the call, and depending on the signals 220, 221 or 222, which determine who set the alarm, will call the appropriate user. The timers further monitor the duration of the call and hang up after the phone has rung a predetermined number of times.

Similarly, if intrusion sensor 118 detects an intrusion, it sends signal TR2 to trigger 262 and to call repeat unit 270. TR2 further also activates green alarm system 120 and thus siren 126. Trigger 262 and call repeat unit 270 activate the same timers as bump sensor 114, but for a different duration. These then set up the call as described above.

Call repeat unit 270 consists of trigger 272, signal generator 274, counter 276, timer 278, and decoder 280. In operation, call repeat unit 270, once triggered using trigger 272, will continue to attempt to telephone the user until one of two events happens. The first is that the user acknowledges the call. This happens if the decoder 280 receives a predetermined character from the user after the user has answered the telephone during one of the attempts to contact him or her. The second event is that counter 276 runs out. When a first trigger event occurs, counter 276 is set to a predetermined value, which could correspond to anything between 1 and 48 hours. The call repeat unit 270 will then attempt to contact the user for this predetermined time period.

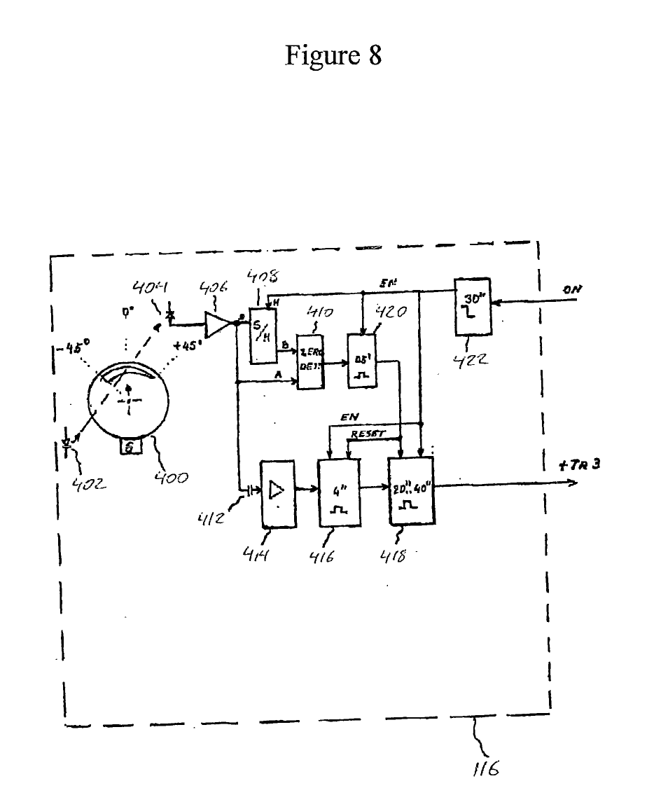

Similarly, tilt sensor 116 triggers both the call repeat unit and trigger 262, causing the alarm unit to activate and to repeatedly attempt to contact the user. In a preferred embodiment of the present invention an automatic zeroing tilt sensor 116 is used. This tilt sensor is illustrated in more detail in FIG. 8.

Tilt sensor 116 is an automatic zeroing sensor that allows the vehicle to be parked on a hill and still be sensitive to tilting of the vehicle. The sensor 116 further allows for the vehicle to experience gusts of wind without being activated.

Tilt sensor 116 comprises an always vertical diaphragm 400 which is mounted in an originally vertical position. Diaphragm 400 communicates with the remaining circuitry in tilt sensor 116 through infrared transmitter 402 which sends signals to infrared receiver 404 about the relative position of diaphragm 400. The signal from infrared receiver 404 is amplified by amplifier 406.

The output of amplifier 406 is sent to three inputs. The first is to register 408. Register 408 captures the tilt position of the vehicle shortly after the vehicle alarm is activated, as is described below. The output of register 408 goes to comparator 410.

The second part of the signal from amplifier 406 goes to comparator 410. Thus, in operation, if the vehicle is moved the signal from the register will be different than the signal currently coming from amplifier 406, and the output of comparator 410 will become low.

The third part of the signal from amplifier 406 is sent through capacitor 412 to remove the DC component. This signal is then amplified by amplifier 414 and sent to delay 416. Delay 416 waits for approximately 4 seconds before activating signal generator 418. Signal generator 418 sends a signal TR3 for a predetermined time period to PCSC 112.

The output of comparator 410 activates signal generator 420 for a predetermined time period. Thus, when the comparator 410 detects that the signal at register 408 and the output of amplifier 406 are the same, it registers a high signal, which activates signal generator 420. Signal generator 420 sends a reset signal for the predetermined time period to timer 416 and signal generator 418.

Tilt sensor 116 further comprises delay component 422. Delay component 422 receives the arming signal from the PCSC to indicate that the alarm has been set. Delay component 422 holds this activation signal for a period of approximately 30 seconds in the preferred embodiment before sending an enable signal to register 408, signal generator 420, delay 416 and signal generator 418. This 30 second delay allows diaphragm 400 to stabilize after the vehicle has been parked.

Thus in operation, tilt sensor 116 is activated through the activation of the alarm at PCSC 112. Approximately thirty seconds later register 408 captures the output of amplifier 406, which reflects the current position of diaphragm 400. Comparator 410 then compares this register 408 value to the current value of the amplifier. If a gust of wind, for example occurs, the comparator will show a difference in value and become low. At the same time, the signal will be amplified and sent to delay 416. Since the event which caused the motion is a gust of wind, the vehicle will generally return to its original position within the delay time of delay 416. This will cause comparator 410 to become high again and will cause signal generator 420 to send a reset signal to timer 416, ensuring no alarm event occurs.

If, conversely, the vehicle is lifted, comparator 410 will not make a subsequent finding that the signals have become the same, and the reset signal from signal generator 420 will not be sent. This will cause delay 416 to activate signal generator 418 once the delay time has expired, which will generate the TR3 event signal.

Referring again to FIG. 5, PCSC 112 further has the capability of receiving an incoming call and processing the data transmitted in this call. Telephone interface 260 triggers timer 282 when a ring signal occurs. This initiates call pickup. Decoder 280 then monitors the signal from telephone interface 260 and sends this information to CPU 284. If the correct codes are entered, CPU 284 sends control signals to engine control 124 based on the data the user has input during the incoming telephone call. This therefore allows the user to control some functions of the vehicle remotely.

System 101 therefore provides an alarm system that uses intelligent sensors to detect whether an alarm event has occurred. If an alarm event occurs, system 101 further contacts the user who set the alarm using a cellular communications system. The system conveys to the user that an alarm event has occurred and further the source of the alarm event. If the user cannot be reached initially, system 101 will continue to attempt to contact the user. Also, system 101 activates, upon receiving an alarm event, an alarm siren that is sensitive to the ambient noise in the environment in which the vehicle is parked.

Although the present invention has been described in detail with regard to the preferred embodiment thereof, one skilled in the art will easily realize that other versions are possible, and the invention is only intended to be limited in scope by the following claims.

We claim:

1. A vehicle alarm system comprising:
a remote control for activation and deactivation of said alarm system;
a multiplicity of sensors for detecting an alarm event;
a siren;
a control unit comprising:
monitoring circuitry for monitoring said multiplicity of sensors;
a receiver for receiving signals from said remote;
an activation and deactivation circuit for activating and deactivating said vehicle alarm system based on signals from said receiver;
a cellular telephone interface unit; and
an alarm triggering unit;
whereupon the detection of said alarm event from one of said multiplicity of sensors said control unit activates said siren through said alarm triggering unit,
and whereupon the detection of said alarm event from one of said multiplicity of sensors, said control unit, through said cellular telephone interface unit, calls a telephone number of a user;
and whereupon the detection of said alarm event from one of said multiplicity of sensors, said control unit signals to said user the cause of the alarm event.

2. The vehicle alarm system of claim 1, wherein said control unit further comprises a timeout unit,
and wherein upon the detection of an alarm event from one of said multiplicity of sensors, said control unit sets said timeout unit, and will continue to attempt to contact a user through said cellular telephone interface unit until either said timeout unit reaches a predetermined value or said user acknowledges said attempt to contact said user.

3. The vehicle alarm system of claims 1 or 2, wherein said alarm activation unit monitors ambient noise around said vehicle alarm system prior to an alarm event, and activates said siren for a variable duration responsive to said ambient noise.

4. The vehicle alarm system of claim 1, 2 or 3 wherein said activation and deactivation unit differentiates between individual users of said vehicle alarm system based on said signals received from said remote control, and wherein said telephone number is determined based on said individual user.

5. The vehicle alarm system of claim 4 wherein said activation and deactivation unit further requires security coded signals from said remote control to activate or deactivate said vehicle alarm system, and wherein said remote is adapted to provide said security coded signals.

6. The remote control of claims 4 or 5 wherein said signals are radio frequency.

7. The remote control of claims 4 or 5 wherein said signals are infrared.

8. The remote control of claims 4 or 5 further comprising a switch, wherein said switch changes said signals between radio frequency and infrared.

9. The vehicle alarm system of claims 1 to 5, wherein said multiplicity of sensors includes an automatic zeroing tilt sensor, said automatic zeroing tilt sensor comprising:
a tilt sensitive diaphragm for producing a tilt value;
comparison circuitry;
activation circuitry; and
a memory unit;
wherein said activation circuitry signals to said memory unit upon activation of said vehicle alarm system to store said tilt value at a moment shortly after said activation;
and wherein said comparison circuitry compares said memory to said tilt value and sends an alarm event if the two become different.

10. The automatic zeroing tilt sensor of claim 9 wherein said comparison unit includes a delay unit, and wherein said delay unit delays the sending of said alarm event,
and wherein said comparator continues to compare said memory and said tilt value after said alarm event, and cancels said alarm event if said tilt value from said tilt sensitive diaphragm returns to said tilt value stored in said memory prior to said delay circuit expiring.

11. A vehicle alarm system comprising:
a remote control for activation and deactivation of said alarm system, wherein said remote control is adapted to send a signal that is security coded and said signal differentiates between individual users;
a multiplicity of sensors for detecting an alarm event, including an automatic zeroing tilt sensor comprising:
a tilt sensitive diaphragm for producing a tilt value;
comparison circuitry;
activation circuitry; and
a memory unit;
wherein said activation circuitry signals to said memory unit upon activation of said vehicle alarm system to store tilt value at a moment shortly after said activation;
and wherein said comparison circuitry compares said memory to said tilt value and sends an alarm event if the two become different.;
a siren;
a control unit comprising:
monitoring circuitry for monitoring said multiplicity of sensors;
a receiver for receiving signals from said remote;
an activation and deactivation circuit for activating and deactivating said vehicle alarm system based on signals from said receiver, wherein said activation and deactivation circuit is adapted to check said security code within said signals;
a cellular telephone interface unit; and
an alarm triggering unit;
whereupon the detection of said alarm event from one of said multiplicity of sensors said control unit activates said siren through said alarm triggering unit,
and whereupon the detection of said alarm event from one of said multiplicity of sensors, said control unit, through said cellular telephone interface unit, calls a telephone number of a user, said telephone number being determined by said signals from said remote control;
and whereupon the detection of said alarm event from one of said multiplicity of sensors, said control unit signals to said user the cause of the alarm event.
